(19) United States
(12) Patent Application Publication
(10) Pub. No.: US 2011/0203406 A1
(43) Pub. Date: Aug. 25, 2011

(54) ONE-PIECE BALL PLUNGER

(75) Inventor: James Dwight Macintyre, Greenwood Lake, NY (US)

(73) Assignee: HOWMEDICA OSTEONICS CORP., Mahwah, NJ (US)

(21) Appl. No.: 12/709,727

(22) Filed: Feb. 22, 2010

(51) Int. Cl. G05G 5/06

(52) U.S. Cl. 74/527

(57) ABSTRACT

A one-piece spring detent has a head portion having an external thread and a drive element at a first end. A coil spring portion of the one-piece spring detent has a first end integrally formed on a second end of the head. The coil spring portion extends away from the second end of the head. A detent element is integrally formed on a second end of the coil spring portion. The detent element has an outer surface for contacting a stop surface on a moving part adjacent the detent.

### BACKGROUND OF THE INVENTION

This invention relates to a one-piece spring loaded detent which produces a pressure control locating of two parts which move relative to one another. In particular, it is related to a threaded one-piece insert which can be mounted in an at least partially threaded bore in one of the two parts which move relative to one another. The one-piece detent produces sufficient pressure on the other one of the two parts to maintain it in position with respect to the part including the one-piece detent mounted thereon under various load conditions which tend to urge relative movement between the two parts.

Multipiece spring loaded detent devices are well known and may be designed as shown in U.S. Pat. No. 2,685,824, which typically includes multiple parts. For example, the pressure control locating device of the '824 patent includes a threaded outer element having a bore therein which receives a spring which in turns receives a plunger, including a contact element which engages one of the movable parts when the device is located in a threaded bore in the other of the movable parts.

Typically, the device is threaded to a depth in a bore in which it is mounted to produce adequate compression under the spring to provide a sufficient biasing force on the contact element to maintain the two parts in place under anticipated loading.

Another typical design includes an outer threaded sleeve having a bore receiving a ball which again is loaded by a spring mounted in a bore in the sleeve. Typically, the leading end of the bore in the sleeve is of a diameter less than the diameter of the ball so that the ball cannot exit the sleeve bore during use. The trailing end of the threaded device includes a drive element used to insert the threaded portion into a threaded bore in one of the parts. The drive may be a hex socket for use with an Allen wrench. Again, the location of the device in the bore of the part on which it is mounted and the spring constant of the spring are chosen to produce sufficient force to hold the two parts in relative position when the leading detent element is engaged, typically in a recess, on the opposite part.

### BRIEF SUMMARY OF THE INVENTION

In one aspect of the invention, a one-piece spring detent is provided which comprises a head portion having an external thread and a drive element and a first end of the head portion. A coil or flexure spring portion is integrally formed on a second end of the head such as by machining at a first end of the coil spring. The integral coil or flexure spring extends away from the second end of the head toward a detent portion. The detent element is integrally formed on a second end of the coil or flexure spring again such as by machining. The one-piece spring detent is mounted on a first part. The integral detent element has an outer surface for contacting a stop surface on a second part moveable relating to the first part. The outer surface of the detent portion may be part spherical in shape for engaging a part spherical depression on the part opposite the part containing the one-piece spring detent. The one-piece spring detent may be machined from a single length of rod.

The coil spring may be helically formed and may have the same pitch as the threads on the head portion of the one-piece spring detent. Typically, the one-piece spring detent is inserted into a bore extending through a first part in a direction toward the second part. However, if it is decided to insert the one-piece spring detent in the opposite direction, i.e., from the bore opening adjacent the second part, then the spring may be helically formed in the opposite direction of the thread on the head while still maintaining the same pitch. Thus, if the head had a right-hand thread, the coil spring would have a left-hand thread. This would prevent the unwinding of the helically coiled spring during insertion in the direction away from the second part.

The thread on the head of the one-piece spring detent has a major diameter greater than an outer diameter of the coil spring portion and detent element portion. The coil spring portion and detent element may have the same diameter or the detent element portion could have a stepped down diameter thus being smaller in diameter than the coil spring portion of the one-piece detent. Forming the detent element portion with a smaller diameter than the coil or flexure spring portion facilitates forming the one-piece detent by injection molding such as plastic injection molding or by metal injection molding (MIM), which injection moldings may be used as an alternate to machining the one-piece detent from metal or plastic. Typically, the head of the one-piece detent has a drive socket such as a hex socket for inserting the detent in a bore in the first part with a suitable tool. In order to facilitate driving the one-piece detent element into the bore in a direction away from the second part, drive elements could be located on the leading detent element portion, which drive elements located on sides of the detent element portion may be spaced away from the contact surface on the detent element. Thus the detent element portion could have a pair of recessed slots on the sides of the detent element spaced from the contact surface of the detent element portion for receiving a suitable tool having a pair of extensions for engaging the recesses. Of course, three or more recesses could be used.

### BRIEF DESCRIPTION OF THE DRAWINGS

FIG. 1 is an isometric view of the one-piece spring detent of the present invention;

FIG. 2 is a cross-sectional view of a typical application of the one-piece spring detent of FIG. 1 holding a first and a second part in relative position to one another;

FIG. 3 is an elevation view of the one-piece spring detent of FIG. 1;

FIG. 4 is an end view of a head end of the one-piece detent of FIG. 3;

FIG. 5 is an end view of a detent element portion of the one-piece detent of FIG. 3;

FIG. 6 is an isometric view of the one-piece spring detent of FIG. 3;

FIG. 7 is an elevation view of an alternate embodiment of a one-piece spring detent;

FIG. 8 is an end view of the detent portion of the spring detent of FIG. 7;

FIG. 9 is an end view of the head portion of the spring detent of FIG. 7;

FIG. 10 is an isometric view of the one-piece spring detent of FIG. 7;

FIG. 11 is an isometric view of a detent element similar to the one shown in FIGS. 1, 6, and 10 with a drive element located on the detent element portion of the one-piece spring detent; and

FIG. 12 is an exploded view of a double acting spring detent used to lock the rotational position of a hinge type joint.

### DETAILED DESCRIPTION

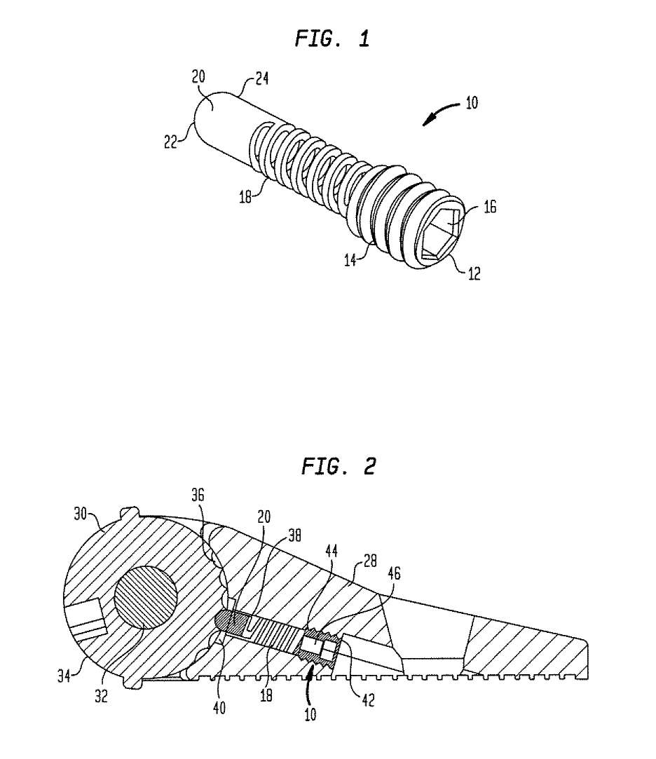

Referring to FIG. 1 there is shown an isometric view of the one-piece spring detent of the present invention generally denoted as 10. Detent 10 includes a head portion 12 having an outer threaded surface 14 and a drive element 16 which, as shown, may be in the form of a hex socket. Spring detent 10 includes an integral spring portion 18 and a detent element portion 20. Detent element portion 20 has a contact surface 22 and a side surface 24. Preferably surface 22 is part-spherical i.e. hemispherical but could also be rounded in any manner or could even be pointed. As shown in FIG. 1, spring portion 18 is a formed wound coil spring with the coil having a square or rectangular cross-section. The cross-section of the coil of spring portion 18 could also be triangular or even circular.

Referring to FIG. 2, by way of example, there is shown a cross-sectional view of one-piece spring detent 10 mounted on a first part 28 on which is rotatably mounted a second part 30. Part 30 rotates about a shaft 32. Outer surface 34 of second part 30 includes a series of part spherical stop surfaces 36, which are shaped to match the part-spherical contact surface 22 of spring detent 10. First part 28 includes a through bore 38, which is open at an inner side 40 and an outer end 42. Bore 38 includes a threaded portion 34, which receives threaded head portion 12 of spring detent 10. As can be seen in the cross-sectional view of detent 10, there is a through bore 46 extending through head portion 12 and through the center of coil spring portion 18. Detent element portion 20 is shown as being solid.

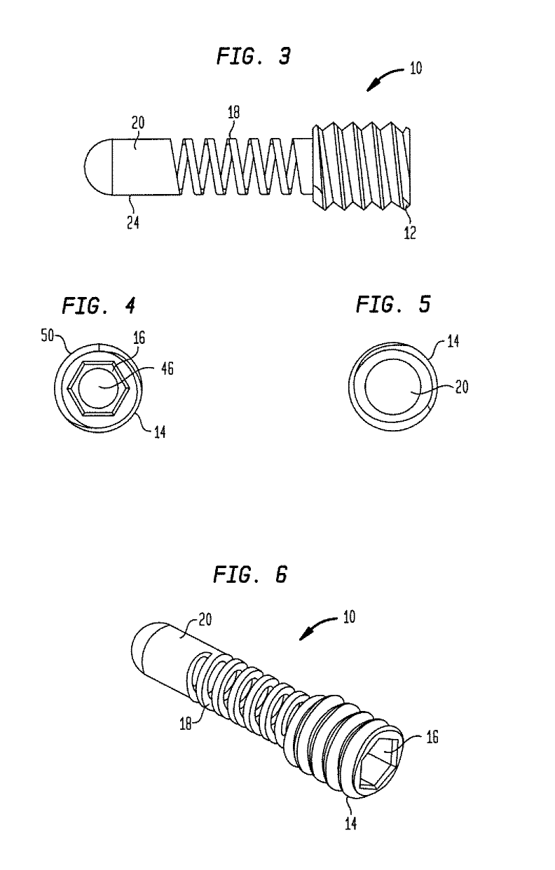

Referring to FIGS. 3-6 one embodiment of spring detent element 10 is shown. Referring to FIG. 4, there is shown the end view of the head end portion 12 of detent 10, which includes a through bore 46 hex socket 16 and the major diameter 50 of threads 14. On the opposite side, as shown in FIG. 5, the detent element portion 20 is shown as well as the major diameter of threaded section 14. It can be seen that the major diameter of thread 14 is larger in diameter than the diameter of detent portion element portion 20 and coil spring 18 portion. Note the coil spring portion 18 and the detent element portion 20 have the same outer diameter. This relationship is again shown in FIG. 6.

The preferred manufacturing process for the detent 10 shown in FIG. 4-6 is to obtain a rod made of any metal but particularly spring steel. The rod would have a diameter greater or equal to the major diameter of threaded head 14. The rod would be placed on a screw turning machine after the rod center had been partially hollowed out by drilling a bore part way therethrough. The screw machine is then used to cut the threads on the head and to cut the helical spring portion 18. The thickness of the coil spring portion 18 is determined by the desired tension. For example a larger diameter outer spring surface coupled a smaller bore 46 thereby produces a thicker spring coil and thus a stronger spring force when compressed. The length of the coil spring portion 18 can also be varied to vary the force produced by the compression of the spring. Preferably the detent element portion 20 is solid at least in the hemispherical portion. While, as indicated above, the pitch on the spring equals the pitch of thread 14 these pitches could be different if so desired.

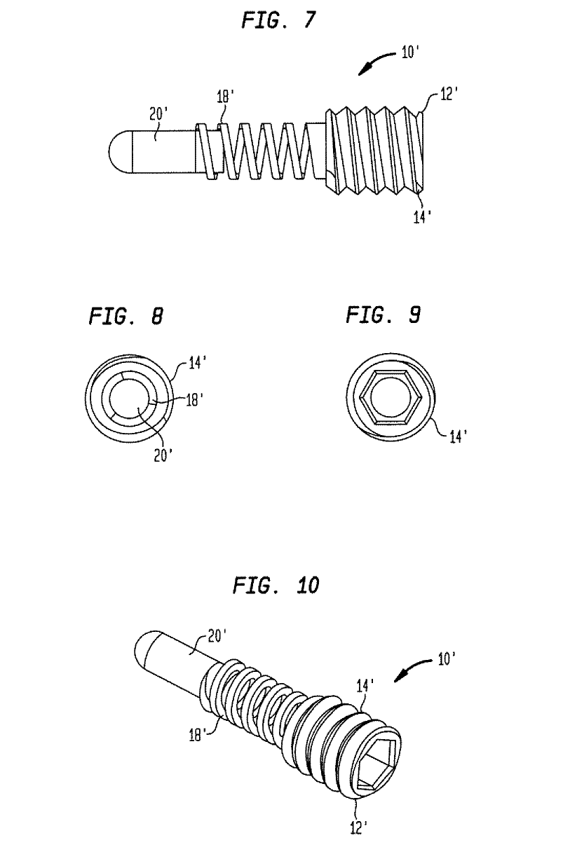

Referring to FIGS. 7-10, a spring detent 10′ is similar to detent 10, except that the diameter of the spring portion 18′ is larger than the diameter of the detent element portion 20′. Both the spring portion 18′ and detent element portion 20′ are smaller in diameter than the major diameter 14′ of head portion 12′. As shown in FIG. 9, the head portion end view is essentially the same as shown in FIG. 4. However, as shown in FIG. 8, the diameter of detent element portion 20′ is smaller than the diameter of coil spring portion 18′. This again is shown in FIG. 10. The design of detent 10′ is to allow the detent to be manufactured by injection molding techniques such as MIM in which powder metallurgy techniques are used to form the one-piece spring detent 10′ in a properly sized mold (not shown). If made of a polymer, plastic injection molding techniques may be used. The reason for the step down diameters is that the preferable method of removal of the one-piece spring detent 10′ from the mold requires it to be screwed out of the mold by rotating head 12′ in the retraction direction after the detent has been molded. Thus, the reduced diameter of the detent element 20′ allows the leading tip of detent 10′ to be more easily removed from the mold.

While two recessed grooves at 180° are described three recessed grooves at 120° or four recessed grooves at 90° may also be used. Also a counter bore using a hex drive could be provided.

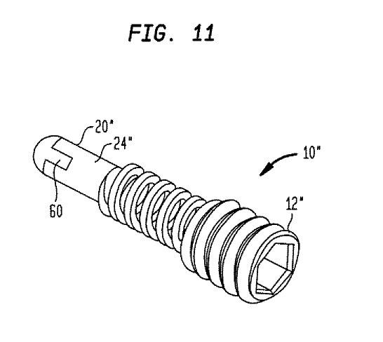

Referring to FIG. 11, there is shown an alternate detent element 10″ which includes a detent element portion 20″ having a side surface 24″ which includes a pair of recessed grooves 60. Only one groove 60 is shown in FIG. 11 with the other groove located 180° from the groove shown, i.e., on the opposite side of detent element 10″. The pair of grooves 60 are provided to receive a turning tool which allows head 12″ to be inserted into a blind bore such as 38 shown in FIG. 2 wherein end 42 would be closed. Thus, the head 12″ would be threaded in from opening 40 of bore 38 by turning detent 10″ with a tool suitable for engaging the pair of grooves 60. Obviously this would be done prior to assembling parts 28 and 30.

Again referring to FIG. 2, the force produced by spring 18 can be varied not only by the thickness of the spring coils, but also by the location of the detent element 20 in relation to the stop element 36. In other words, the more the detent element 20 extends outwardly of the end 40 of bore 38, the greater the compression of coil spring portion 18 upon engagement with second part 30 and thus the greater the force produced preventing the relative movement between first part 28 and second part 30. While spring detent 10 is shown mounted to prevent relative rotation between first part 28 and second part 30, the detent could be used to prevent linear motion of the two parts 28, 30 in any direction. Also parts 28 and 30 could be adjacent planar surfaces held in place by detent 10.

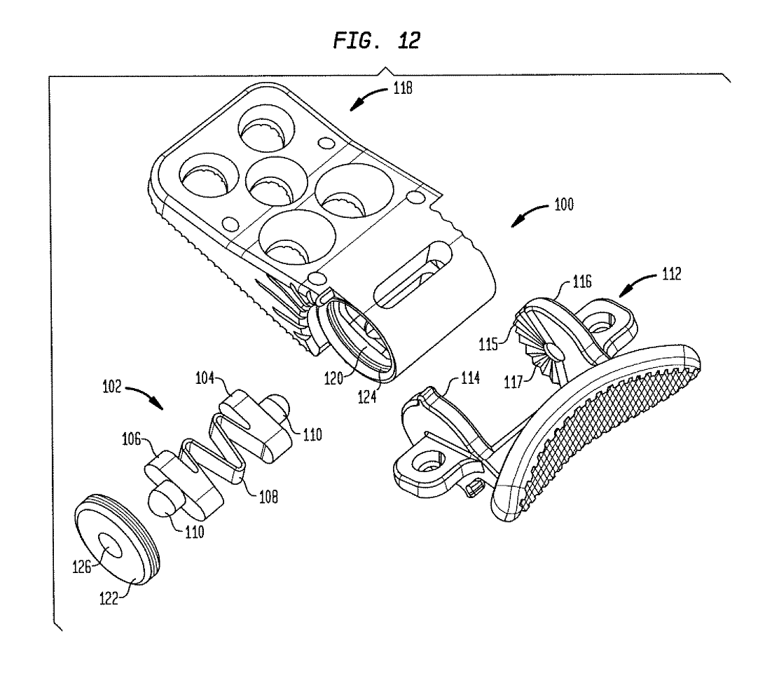

Referring to FIG. 12 there is shown a double acting spring detent used in a hinge system generally denoted at 100 A spring detent 102 includes a first detent plate 104 and a second detent plate 106 separated by an integral spring section 108. Each plate 104, 106 included a detent button 110. As stated above, the integral spring 108 and plate 104, 106 are preferably injection molded of metal or plastic.

A hinge element 112 includes a pair of plates 114 and 116 having a series of peaks 115 and valleys 117 to receive detent button 110 of a respective detent plate 106, 108. A hinge element 118 includes a bore 120 for receiving spring detent 102. A pair of flanges 122 (only one is shown) are threadably received in a threaded end portion 124 on both ends of bore 120. Each flange 122 has a central opening 126 for slidably receiving detent button 110.

Once assembled, hinge elements 112 and 118 are held in relative rotational position by the engagement of detent buttons 110 and the valleys 117 on each plate 114, 116. As shown spring 108 is a flexure spring but could also be a coil spring.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A one-piece spring detent comprising:
a head portion having an external thread and a drive element at a first end;
a spring portion having a first end integrally formed on a second end of the head, the spring portion extending away from the second end of the head; and
a detent element integrally formed on a second end of the spring portion, the detent element having an outer surface for contacting a stop surface adjacent the detent.

2. The one-piece spring detent as set forth in claim 1, wherein the spring portion is a helically formed coil spring.

3. The one-piece spring detent as set forth in claim 2, wherein the head extend thread is a helical thread.

4. The one-piece spring detent as set forth in claim 3, wherein the helical form of the coil spring is in the opposite direction of the helical thread.

5. The one-piece spring detent as set forth in claim 4, wherein the external thread has a major diameter greater than an outer diameter of the coil spring portion and detent element portion.

6. The one-piece spring detent as set forth in claim 5, wherein the detent element portion and coil spring portion have outer diameters which are equal.

7. The one-piece spring detent as set forth in claim 5, wherein the coil spring portion has a diameter larger than a diameter of the detent element portion.

8. The one-piece spring detent as set forth in claim 1, wherein the head portion has a hex socket formed therein.

9. A one-piece spring loaded detent comprising:
a head portion having an external thread with a major diameter and first end with a drive element;
a helical spring portion having a first end integrally attached to a second end of the head portion, the helical spring portion having a second diameter; and
a tip portion having a first end integrally attached to a second end of the helical spring portion, the tip having a second end capable of engaging a surface capable of compressing the helical spring portion.

10. The one-piece spring loaded detent as set forth in claim 9, wherein the external thread of the head is a helical thread.

11. The one-piece spring loaded detent as set forth in claim 10, wherein the helical spring portion and the helical thread have the same pitch.

12. The one-piece spring loaded detent as set forth in claim 11, wherein the helical form of the helical spring portion is in the opposite direction of the helical thread on the head portion wherein the tip portion has a third diameter.

13. The one-piece spring loaded detent as set forth in claim 9 wherein the tip portion has a third diameter.

14. The one-piece spring loaded detent as set forth in claim 13, wherein the thread major diameter is greater than the second and third diameters.

15. The one-piece spring loaded detent as set forth in claim 14, wherein the second and third diameters are equal.

16. The one-piece spring loaded detent as set forth in claim 14, wherein the second diameter is greater than the third diameter.

17. The one-piece spring loaded detent as set forth in claim 9, wherein the drive element is a hex socket open to the first end of the head portion.

18. The one-piece spring detent element as set forth in claim 1 wherein the spring is a flexure spring.
